(19) United States
(12) Patent Application Publication
(10) Pub. No.: US 2012/0230260 A1
(43) Pub. Date: Sep. 13, 2012

(54) Apparatus and Method for Allocating Communication Resources in a Communication System

(76) Inventors: Elena Virtej, Espoo (FI); Jari Petteri Lundén, Espoo (FI)

(21) Appl. No.: 13/043,161

(22) Filed: Mar. 8, 2011

(51) Int. Cl. H04W 72/04

(52) U.S. Cl. 370/329

(57) ABSTRACT

An apparatus, method and system for allocating communication resources in a communication system. In one embodiment, an apparatus includes a processor and memory including computer program code. The memory and the computer program code are configured to, with the processor, cause the apparatus to monitor communication resources employed by a plurality of base stations, determine an opportunity for improved utilization of the communication resources by the apparatus and the plurality of base stations, and generate a change request for the communication resources employed by at least one of the plurality of base stations based on the opportunity for improved utilization thereof.

### TECHNICAL FIELD

The present invention is directed, in general, to communication systems and, in particular, to an apparatus, method and system to allocate communication resources in a communication system.

### BACKGROUND

Long term evolution (“LTE”) of the Third Generation Partnership Project (“3GPP”), also referred to as 3GPP LTE, refers to research and development involving the 3GPP LTE Release 8 and beyond, which is the name generally used to describe an ongoing effort across the industry aimed at identifying technologies and capabilities that can improve systems such as the universal mobile telecommunication system (“UMTS”). The notation “LTE-A” is generally used in the industry to refer to further advancements in LTE. The goals of this broadly based project include improving communication efficiency, lowering costs, improving services, making use of new spectrum opportunities, and achieving better integration with other open standards.

The evolved universal terrestrial radio access network (“E-UTRAN”) in 3GPP includes base stations providing user plane (including packet data convergence protocol/radio link control/medium access control/physical (“PDCP/RLC/MAC/PHY”) layers) and control plane (including a radio resource control/radio link control/medium access control/physical (“RRC/RLC/MAC/PHY”) layers) protocol terminations towards wireless communication devices such as cellular telephones. A wireless communication device or terminal is generally known as user equipment (also referred to as “UE”). A base station is an entity of a communication network often referred to as a Node B or an NB. Particularly in the E-UTRAN, an “evolved” base station is referred to as an eNodeB or an eNB. For details about the overall architecture of the E-UTRAN, see 3GPP Technical Specification (“TS”) 36.300 v8.7.0 (2008-12), which is incorporated herein by reference. For details of the radio resource control management, see 3GPP TS 25.331 v.9.1.0 (2009-12) and 3GPP TS 36.331 v.9.1.0 (2009-12), which are incorporated herein by reference.

As wireless communication systems such as cellular telephone, satellite, and microwave communication systems become widely deployed and continue to attract a growing number of users, there is a pressing need to accommodate a large and variable number of communication devices that transmit an increasing quantity of data within a fixed spectral allocation and limited transmit power. The increased quantity of data is a consequence of wireless communication devices transmitting video information and surfing the Internet, as well as performing ordinary voice communications. Such processes must be performed while accommodating substantially simultaneous operation of a large number of wireless communication devices.

To provide improved capability to transmit an increasing quantity of data, future communication systems such as cellular communication systems are expected to implement a distributed flexible spectrum use (“FSU”) mechanism. With flexible spectrum use, the base stations of the communication system coordinate reuse of communication resources (e.g. radio communication resources) in a distributed way (i.e., without the use of a central control element) to improve a performance characteristic of the communication system such as fairness, capacity, and efficiency, or some other measure of performance. As a benefit, such a communication system may not employ frequency planning or other traditional planning techniques. Instead, the communication system arranges sharing of spectrum communication resources in a self-organizing manner. Hence, flexible spectrum use is especially suited for local area deployments that will likely include small, multiple, overlapping areas (such as cells), placed without overall coordination, possibly by the end users of wireless communication devices themselves.

Due to the uncoordinated nature of communication system deployments, particularly of indoor cellular deployments, self-optimization mechanisms are employed to distribute communication resources among the base stations. For this purpose, a flexible spectrum use scheme may be deployed. In present flexible spectrum use, the reservation inventory of a base station's communication resources is allocated with scheduling arrangements that are optimized on a serving area or cell level. The scheduling arrangements can deal with a directly neighboring cell, and communication resource use is coordinated with the directly neighboring base station. For many cases, the resulting communication resource reuse pattern provides an adequate result, but in certain cases it can lead to inefficiencies in spectrum usage from a broader perspective of what communication resources could be allocated across a communication system of neighboring base stations.

In view of the growing deployment of communication systems such as cellular communication systems and the growing utilization bandwidth for video and other bandwidth-intensive applications, it would be beneficial in the utilization of flexible spectrum use scheduling arrangements to employ a system and method that accounts for spectrum utilization of wireless communication devices in an area served by one base station and wireless communication devices in another area served by another base station that avoids the deficiencies of current communication systems.

### SUMMARY OF THE INVENTION

These and other problems are generally solved or circumvented, and technical advantages are generally achieved, by embodiments of the present invention, which include an apparatus, method and system to allocate communication resources in a communication system. In one embodiment, an apparatus includes a processor and memory including computer program code. The memory and the computer program code are configured to, with the processor, cause the apparatus to monitor communication resources employed by a plurality of base stations including neighboring and more remote base stations, determine an opportunity for improved utilization of the communication resources by the apparatus and the plurality of base stations, and generate a change request for the communication resources employed by at least one of the plurality of base stations based on the opportunity for improved utilization thereof.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the invention, and the advantages thereof, reference is now made to the following descriptions taken in conjunction with the accompanying drawings, in which:

FIGS. 1 and 2 illustrate system level diagrams of embodiments of communication systems including a base station and wireless communication devices that provide an environment for application of the principles of the present invention;

FIGS. 3 and 4 illustrate system level diagrams of embodiments of communication systems including wireless communication systems that provide an environment for application of the principles of the present invention;

FIG. 5 illustrates a system level diagram of an embodiment of a communication element of a communication system for application of the principles of the present invention;

FIG. 6 illustrates a system level diagram of an embodiment of a communication system illustrating exemplary flexible spectrum use by first and second base stations that provides an environment for the application of the principles of the present invention;

FIG. 7 illustrates a system level diagram of an embodiment of a communication system demonstrating exemplary flexible spectrum reuse that provides an environment for the application of the principles of the present invention;

FIG. 8 illustrates a system level diagram of an embodiment of a communication system demonstrating exemplary flexible spectrum use operation according to the principles of the present invention; and

FIG. 9 illustrates a flow diagram of an embodiment of a method of operating a communication element in accordance with the principles of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. In view of the foregoing, the present invention will be described with respect to exemplary embodiments in a specific context of an apparatus, method and system that accounts for spectrum utilization of wireless communication devices in an area served by one base station and wireless communication devices in another area served by another base station. The apparatus, method and system are applicable, without limitation, to any communication system including existing and future 3GPP technologies such as UMTS, LTE, and its future variants such as 4th generation (“4G”) communication systems.

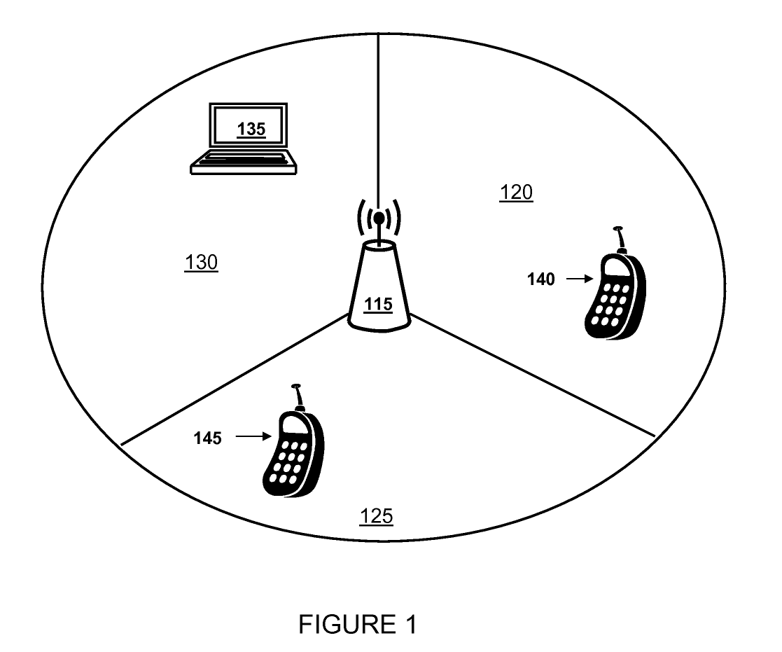

Turning now to FIG. 1, illustrated is a system level diagram of an embodiment of a communication system including a base station 115 and wireless communication devices (e.g., user equipment) 135, 140, 145 that provides an environment for application of the principles of the present invention. The base station 115 is coupled to a public switched telephone network (not shown). The base station 115 is configured with a plurality of antennas to transmit and receive signals in a plurality of sectors including a first sector 120, a second sector 125, and a third sector 130, each of which typically spans 120 degrees. Although FIG. 1 illustrates one wireless communication device (e.g., wireless communication device 140) in each sector (e.g. the first sector 120), a sector (e.g. the first sector 120) may generally contain a plurality of wireless communication devices. In an alternative embodiment, a base station 115 may be formed with only one sector (e.g. the first sector 120), and multiple base stations may be constructed to transmit according to co-operative multi-input/multi-output (“C-MIMO”) operation, etc.

The sectors (e.g. the first sector 120) are formed by focusing and phasing radiated signals from the base station antennas, and separate antennas may be employed per sector (e.g. the first sector 120). The plurality of sectors 120, 125, 130 increases the number of subscriber stations (e.g., the wireless communication devices 135, 140, 145) that can simultaneously communicate with the base station 115 without the need to increase the utilized bandwidth by reduction of interference that results from focusing and phasing base station antennas. While the wireless communication devices 135, 140, 145 are part of a primary communication system, the wireless communication devices 135, 140, 145 and other devices such as machines (not shown) may be a part of a secondary communication system to participate in, without limitation, D2D and machine-to-machine communications or other communications.

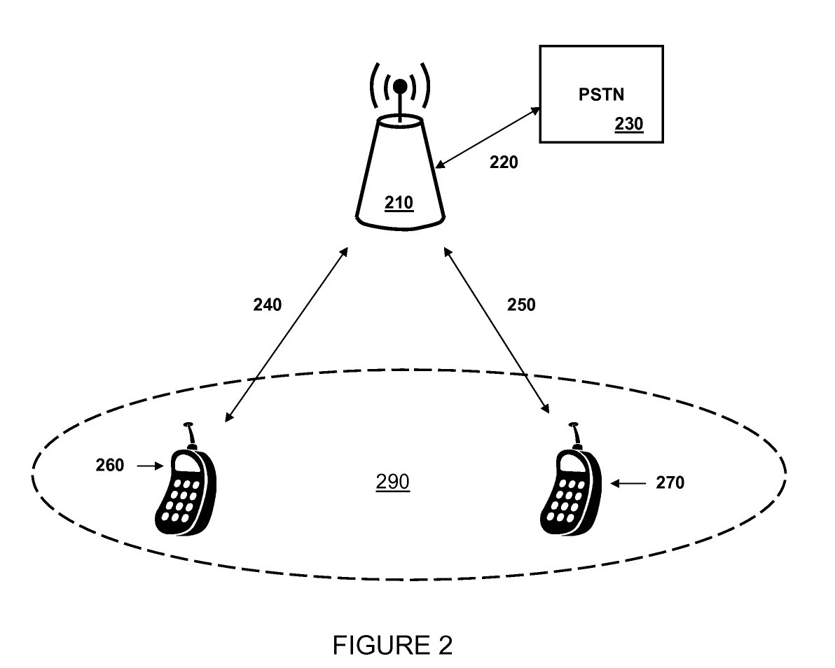

Turning now to FIG. 2, illustrated is a system level diagram of an embodiment of a communication system including a base station 210 and wireless communication devices (e.g., user equipment) 260, 270 that provides an environment for application of the principles of the present invention. The communication system includes the base station 210 coupled by communication path or link 220 (e.g., by a fiber-optic communication path) to a core telecommunications network such as public switched telephone network (“PSTN”) 230. The base station 210 is coupled by wireless communication paths or links 240, 250 to the wireless communication devices 260, 270, respectively, that lie within its cellular area 290.

In operation of the communication system illustrated in FIG. 2, the base station 210 communicates with each wireless communication device 260, 270 through control and data communication resources allocated by the base station 210 over the communication paths 240, 250, respectively. The control and data communication resources may include frequency and time-slot communication resources in frequency division duplex (“FDD”) and/or time division duplex (“TDD”) communication modes. While the wireless communication devices 260, 270 are part of a primary communication system, the wireless communication devices 260, 270 and other devices such as machines (not shown) may be a part of a secondary communication system to participate in, without limitation, device-to-device and machine-to-machine communications or other communications.

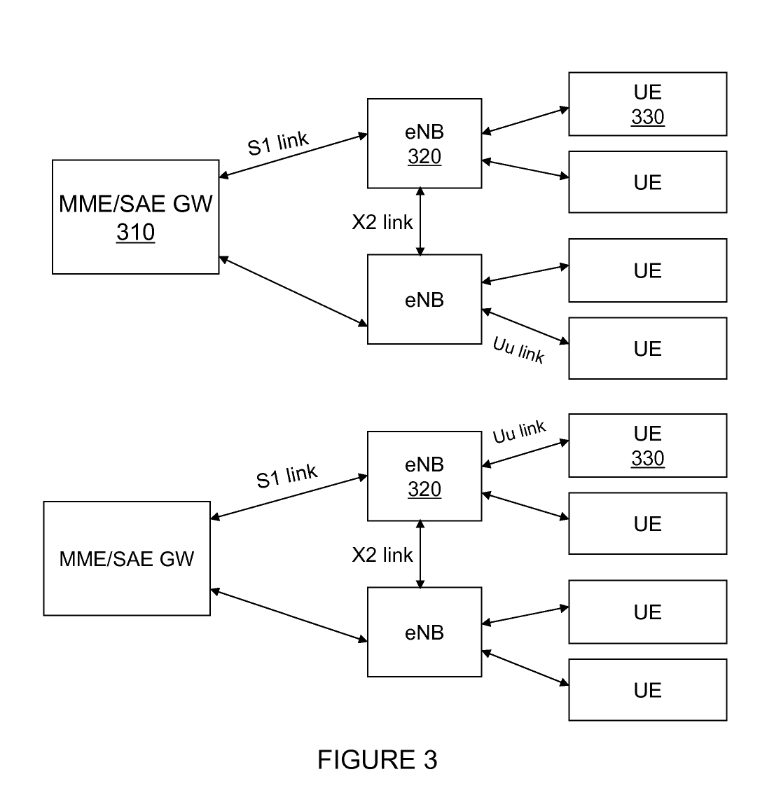

Turning now to FIG. 3, illustrated is a system level diagram of an embodiment of a communication system including a wireless communication system that provides an environment for the application of the principles of the present invention. The wireless communication system may be configured to provide evolved UMTS terrestrial radio access network (“E-UTRAN”) universal mobile telecommunications services. A mobile management entity/system architecture evolution gateway (“MME/SAE GW,” one of which is designated 310) provides control functionality for an E-UTRAN node B (designated “eNB,” an “evolved node B,” also referred to as a “base station,” one of which is designated 320) via an S1 communication link (ones of which are designated “S1 link”). The base stations 320 communicate via X2 communication links (ones of which are designated “X2 link”). The various communication links are typically fiber, microwave, or other high-frequency communication paths such as coaxial links, or combinations thereof. In addition to or in lieu of, the base stations 320 may communicate on over-the-air communication paths.

The base stations 320 communicate with wireless communication devices such as user equipment (“UE,” ones of which are designated 330), which is typically a mobile transceiver carried by a user. Thus, the communication links (designated “Uu” communication links, ones of which are designated “Uu link”) coupling the base stations 320 to the user equipment 330 are frequency division multiplex (“OFDM”) signal. While the user equipment 330 are part of a primary communication system, the user equipment 330 and other devices such as machines (not shown) may be a part of a secondary communication system to participate in, without limitation, D2D and machine-to-machine communications or other communications.

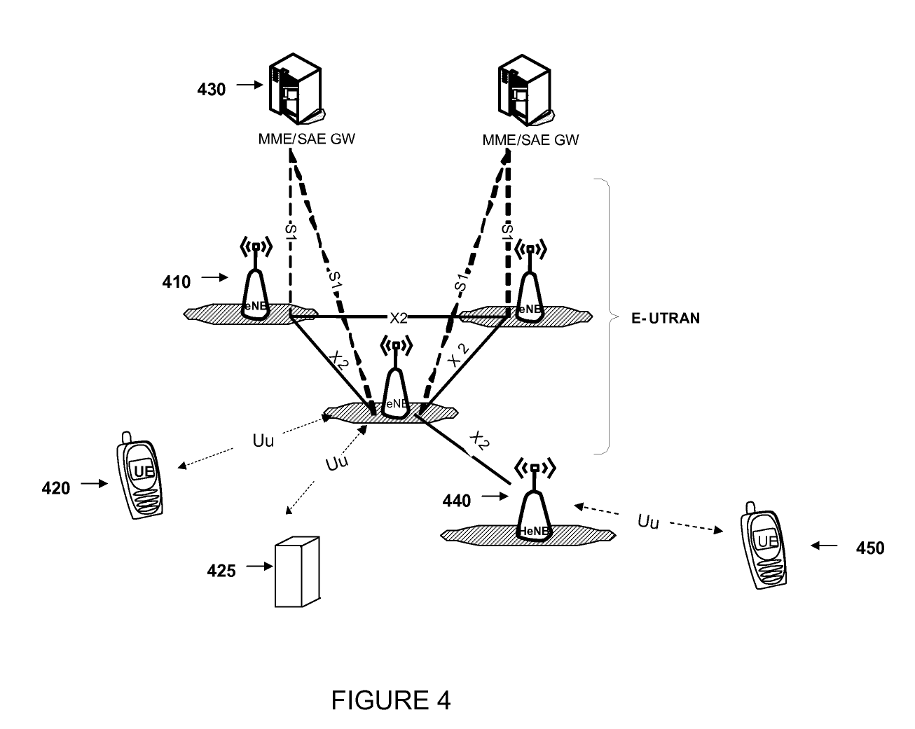

Turning now to FIG. 4, illustrated is a system level diagram of an embodiment of a communication system including a wireless communication system that provides an environment for the application of the principles of the present invention. The wireless communication system provides an E-UTRAN architecture including base stations (one of which is designated 410) providing E-UTRAN user plane (packet data convergence protocol/radio link control/medium access control/physical layer) and control plane (radio resource control/radio link control/medium access control/physical layer) protocol terminations towards wireless communication devices such as user equipment 420 and other devices such as machines 425 (e.g., an appliance, television, meter, etc.). The base stations 410 are interconnected with X2 interfaces or communication links (designated “X2”). The base stations 410 are also connected by S1 interfaces or communication links (designated “S1”) to an evolved packet core (“EPC”) including a mobile management entity/system architecture evolution gateway (“MME/SAE GW,” one of which is designated 430). The S1 interface supports a multiple entity relationship between the mobile management entity/system architecture evolution gateway 430 and the base stations 410. For applications supporting inter-public land mobile handover, inter-eNB active mode mobility is supported by the mobile management entity/system architecture evolution gateway 430 relocation via the S1 interface.

The base stations 410 may host functions such as radio resource management. For instance, the base stations 410 may perform functions such as internet protocol (“IP”) header compression and encryption of user data streams, ciphering of user data streams, radio bearer control, radio admission control, connection mobility control, dynamic allocation of communication resources to user equipment in both the uplink and the downlink, selection of a mobility management entity at the user equipment attachment, routing of user plane data towards the user plane entity, scheduling and transmission of paging messages (originated from the mobility management entity), scheduling and transmission of broadcast information (originated from the mobility management entity or operations and maintenance), and measurement and reporting configuration for mobility and scheduling. The mobile management entity/system architecture evolution gateway 430 may host functions such as distribution of paging messages to the base stations 410, security control, termination of user plane packets for paging reasons, switching of user plane for support of the user equipment mobility, idle state mobility control, and system architecture evolution bearer control. The user equipment 420 and machines 425 receive an allocation of a group of information blocks from the base stations 410.

Additionally, the ones of the base stations 410 are coupled to a home base station 440 (a device), which is coupled to devices such as user equipment 450 and/or machines (not shown) for a secondary communication system. The base station 410 can allocate secondary communication system resources directly to the user equipment 450 and machines, or to the home base station 440 for communications (e.g., local or D2D communications) within the secondary communication system. The secondary communication resources can overlap with communication resources employed by the base station 410 to communicate with the user equipment 420 within its serving area. For a better understanding of home base stations (designated “HeNB”), see 3 GPP TS 32.781 v.9.1.0 (2010-03), which is incorporated herein by reference. While the user equipment 420 and machines 425 are part of a primary communication system, the user equipment 420, machines 425 and home base station 440 (communicating with other user equipment 450 and machines (not shown)) may be a part of a secondary communication system to participate in, without limitation, D2D and machine-to-machine communications or other communications.

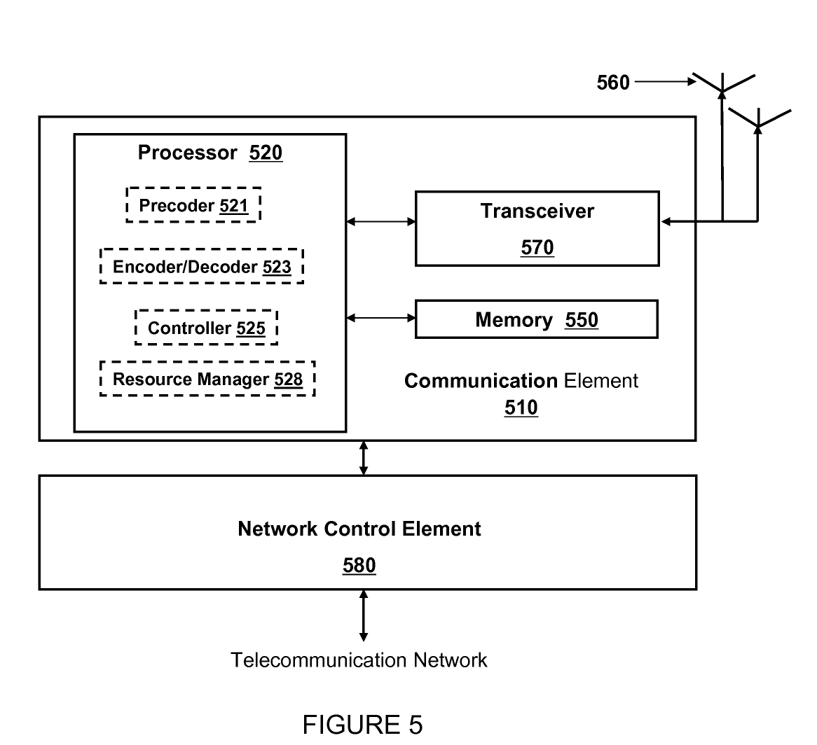

Turning now to FIG. 5, illustrated is a system level diagram of an embodiment of a communication element 510 of a communication system for application of the principles of the present invention. The communication element or device 510 may represent, without limitation, a base station, a wireless communication device (e.g., a subscriber station, terminal, mobile station, user equipment, machine), a network control element, a communication node, or the like. When the communication element or device 510 represents a user equipment, the user equipment may be configured to communicate with another user equipment employing one or more base stations as intermediaries in the communication path (referred to as cellular communications). The user equipment may also be configured to communicate directly with another user equipment without direct intervention of the base station in the communication path (referred to as device-to-device (“D2D”) communications). The communication element 510 includes, at least, a processor 520, memory 550 that stores programs and data of a temporary or more permanent nature, an antenna 560, and a radio frequency transceiver 570 coupled to the antenna 560 and the processor 520 for bidirectional wireless communications. The communication element 510 may be formed with a plurality of antennas to enable a multiple-input multiple output (“MIMO”) mode of operation. The communication element 510 may provide point-to-point and/or point-to-multipoint communication services.

The communication element 510, such as a base station in a cellular communication system or network, may be coupled to a communication network element, such as a network control element 580 of a public switched telecommunication network (“PSTN”). The network control element 580 may, in turn, be formed with a processor, memory, and other electronic elements (not shown). The network control element 580 generally provides access to a telecommunication network such as a PSTN. Access may be provided using fiber optic, coaxial, twisted pair, microwave communications, or similar link coupled to an appropriate link-terminating element. A communication element 510 formed as a wireless communication device is generally a self-contained device intended to be carried by an end user.

The processor 520 in the communication element 510, which may be implemented with one or a plurality of processing devices, performs functions associated with its operation including, without limitation, precoding of antenna gain/phase parameters (precoder 521), encoding and decoding (encoder/decoder 523) of individual bits forming a communication message, formatting of information, and overall control (controller 525) of the communication element 510. Exemplary functions related to management of communication resources include, without limitation, hardware installation, traffic management, performance data analysis, tracking of end users and equipment, configuration management, end user administration, management of wireless communication devices, management of tariffs, subscriptions, security, billing and the like. For instance, in accordance with the memory 550, the resource manager 528 of the processor 520 is configured to allocate primary and second communication resources (e.g., time and frequency communication resources) for transmission of voice communications and data to/from the communication element 510 and to format messages including the communication resources therefor in a primary and secondary communication system.

In accordance therewith, the resource manager 528 of the processor 520 (in accordance with the memory 550) of a communication element (e.g., a base station) is configured to receive information about communication resources employed by at least one of a plurality of base stations (including neighboring and more remote base stations) from a user equipment in a serving area of the base station or from one of the plurality of base stations and monitor the communication resources employed by the plurality of base stations. The resource manager 528 of the processor 520 is also configured to determine an opportunity for improved utilization of the communication resources by the base station and the plurality of base stations, and generate a change request for the communication resources employed by at least one of the plurality of base stations (or by the base station itself) based on the opportunity for improved utilization thereof (which may be dependent on a distance or a path loss between ones of the plurality of base stations). The resource manager 528 of the processor 520 is configured to generate an exchange of communication resources employed between two of the plurality of base stations.

In accordance therewith, the processor 520 (via a transceiver) configured to transmit the change request to at least one of the plurality of base stations, receive acknowledgements to the change request and initiate a change in response to the acknowledgements. In another embodiment, the processor 520 (via a transceiver) is configured to transmit the change request to at least one of the plurality of base stations and receive an acknowledgement from one of the plurality of base stations, wherein the acknowledgement is a function of a subsequent change request from the one of the plurality of base stations to another of the plurality of base stations. In another embodiment, the communication resources include unused communication resources for the base station and the resource manager 528 of the processor 520 is configured to generate a change request for at least one of the unused communication resources employed by at least one of the plurality of base stations, thereby freeing up the at least one of the unused communication resources for the base station.

The execution of all or portions of particular functions or processes related to management of communication resources may be performed in equipment separate from and/or communicated for execution to the communication element 510. The processor 520 of the communication element 510 may be of any type suitable to the local application environment, and may include one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as non-limiting examples.

The transceiver 570 of the communication element 510 modulates information on to a carrier waveform for transmission by the communication element 510 via the antenna(s) 560 to another communication element. The transceiver 570 demodulates information received via the antenna(s) 560 for further processing by other communication elements. The transceiver 570 is capable of supporting duplex operation for the communication element 510.

The memory 550 of the communication element 510, as introduced above, may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. The programs stored in the memory 550 may include program instructions or computer program code that, when executed by an associated processor, enable the communication element 510 to perform tasks as described herein. Of course, the memory 550 may form a data buffer for data transmitted to and from the communication element 510. Exemplary embodiments of the system, subsystems, and modules as described herein may be implemented, at least in part, by computer software executable by processors of, for instance, the wireless communication device and the base station, or by hardware, or by combinations thereof. As will become more apparent, systems, subsystems and modules may be embodied in the communication element 510 as illustrated and described herein.

As mentioned above, due to the possibly uncoordinated nature of communication system deployments such as cellular communication system deployments, self-optimization mechanisms such as flexible spectrum use are employed to distribute communication resources such as time and frequency communication resource elements among base stations. Flexible spectrum use is based on creating and spreading local awareness in the communication system, which allows intelligent, self-organizing, flexible spectrum use. In practice, this can be implemented using base station beaconing, wherein each base station broadcasts flexible spectrum use beacons containing information on its spectrum utilization, priority, and other flexible spectrum utilization related information. A base station is the functional access point (“AP”) between user equipment and the communication system. Nearby user equipment (even if connected to another base station) can monitor these beacons to collect information describing spectrum utilization at their location. The user equipment then report their findings to their serving base stations, which combine information from connected user equipment to form local awareness of spectrum utilization in the serving area and (possibly) other areas (e.g., neighboring cells), and can take action to allocate or otherwise utilize communication resources (e.g., to reserve more communication resources for the serving area).

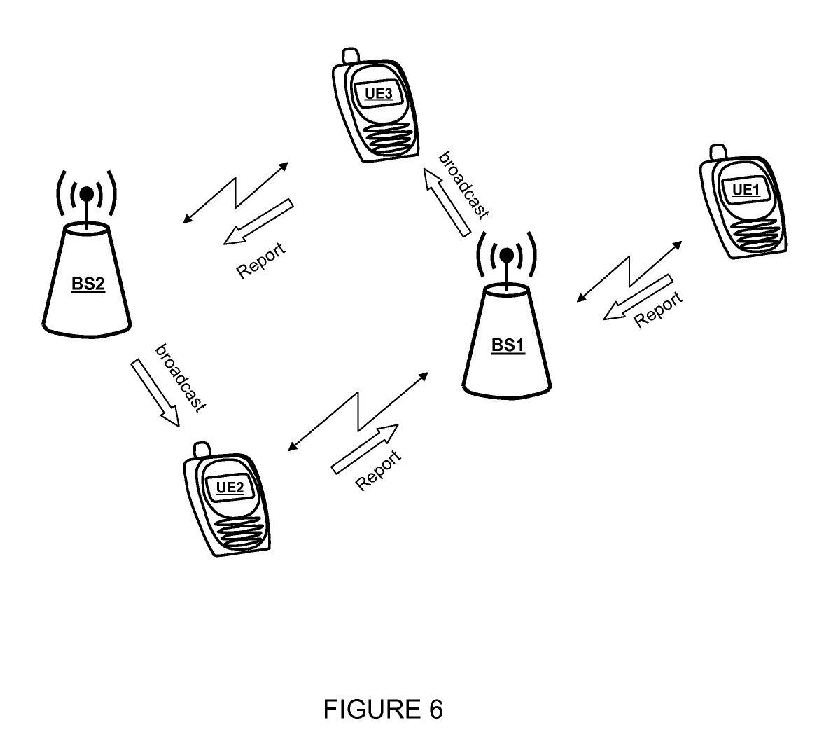

Turning now to FIG. 6, illustrated is a system level diagram of an embodiment of a communication system illustrating exemplary flexible spectrum use by first and second base stations BS1, BS2 that provides an environment for the application of the principles of the present invention. The first and second base stations BS1, BS2 broadcast information, such as in a system information broadcast or by point-to-point communication to user equipment, describing spectrum use to user equipment within the respective serving areas. For example, first and second user equipment UE1, UE2 are served by the first base station BS1, and a third user equipment UE3 is served by the second base station BS2. The information transmitted by a base station may contain a base station identification number (“BSID”), reserved communication resources (e.g. an inventory of communication resources), and an indication of spectrum coordination support. The user equipment receive beacons of neighboring base stations and also possibly of their serving base stations and report the obtained information to their respective serving base station. As illustrated in FIG. 6, the second user equipment UE2 receives a broadcast from the second base station BS2, which is not its serving base station, and reports the obtained information to its serving base station (the first base station BS1). The serving base station combines reported information from connected user equipment in its serving area to obtain a collective view of communication resource use in other serving areas (e.g., neighboring cells). In this example, the first base station BS1 combines information it receives from the second user equipment UE2 with its own information to form a collective view of communication resources used by itself and by the second base station BS2 (e.g., a neighboring base station). For exemplary references related to flexible spectrum use, see PCT Application No. PCT/IB2009/007339 entitled “Priority-Based Fairness and Interference Signalling Technique in a Flexible Spectrum Use Wireless Communication System,” to Lunden, et al., filed Nov. 5, 2009 and PCT Application No. PCT/IB2009/007340 entitled “Automated Local Spectrum Usage Awareness,” to Lunden, et al., filed Nov. 5, 2009, which are incorporated herein by reference.

In a communication system that employs flexible spectrum use wherein frequency reuse is configured dynamically on a serving area (or cell) level, flexible spectrum use control is distributed among individual cells. Each cell reserves its own resources, and access on those resources is governed by a processor (e.g., resource manager 528 of the processor 520 illustrated in FIG. 5) in the respective base station. Signaling of communication resource reservations between neighboring areas (or cells) is arranged, for example, using flexible spectrum use broadcast beacons from such access points or base stations, or using X2 or other direct communication links (such as over-the-air communication paths) between the base stations.

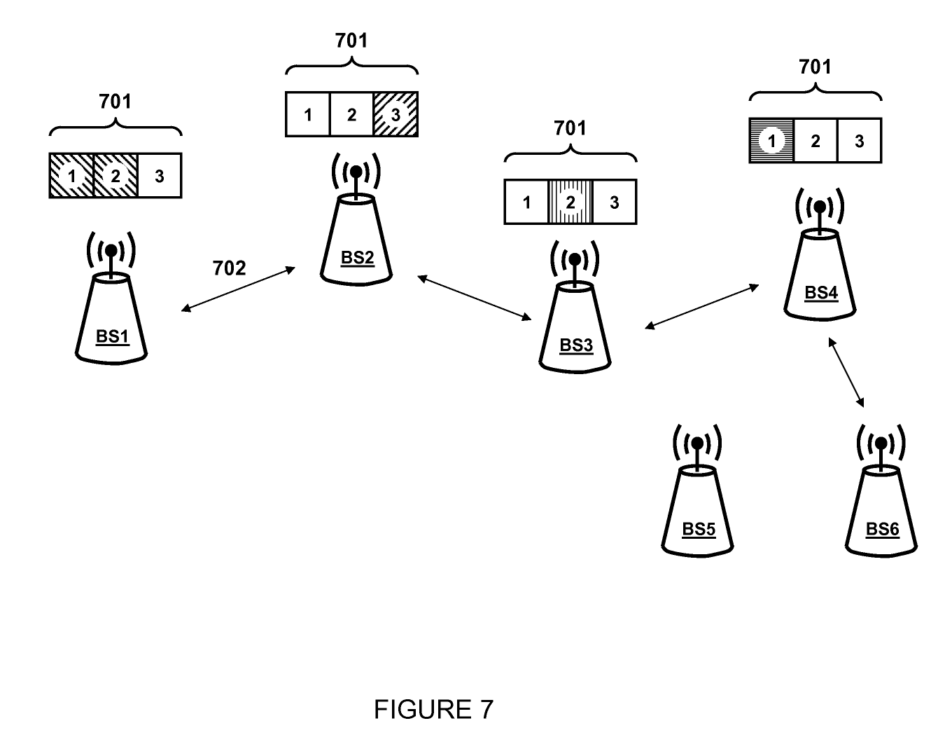

Turning now to FIG. 7, illustrated is a system level diagram of an embodiment of a communication system demonstrating exemplary flexible spectrum reuse that provides an environment for application of the principles of the present invention. In the illustrated embodiment, three orthogonal resources, collectively illustrated by orthogonal resources 701 and labeled 1, 2, and 3, accessible over a spectrum of frequencies to first, second, third and fourth base stations BS1, BS2, BS3, and BS4, are employed for communication between the respective base stations and user equipment in its serving area. The user equipment are omitted from the drawing for simplicity. Focusing on the first, second, third and fourth base stations BS1, BS2, BS3, and BS4, the arrows between the base stations, such as bi-directional arrow 702, indicate flexible spectrum use coordination by exchange of messages among the base stations. Neighboring base stations coordinate spectrum reuse so that the same communication resources are not reused by neighboring base stations to avoid interference. These coordination relationships are established by the flexible spectrum use process and depend, for example, on distances/path losses between cells and/or on distances/path losses between user equipment and their respective base stations and/or neighboring base stations.

It can be observed in FIG. 7 that the reuse pattern resulting from flexible spectrum use coordination among base stations is inefficient at the third base station BS3. The second and fourth base stations BS2, BS4 reserve one communication resource (e.g., communication resources 3 and 1, respectively), but these communication resources are not the same communication resource and, thus, only one communication resource (e.g., communication resource 2) is available for use by the third base station BS3. If the second and fourth base stations BS2, BS4 use the same communication resource, this would free one additional communication resource for the use of the third base station BS3 without any loss to the second and fourth base stations BS2, BS4 because such base stations are substantially distant and do not mutually interfere. This change would, of course, propagate further in the communication system to neighboring areas (e.g., cells) of the second and fourth base stations BS2, BS4 such as neighboring areas served by fifth and sixth base stations BS5, BS6. In the case of the second base station BS2, there is only one neighboring base station (e.g., the first base station BS1). Therefore, the first and second base stations BS1, BS2 can just rearrange their communication system.

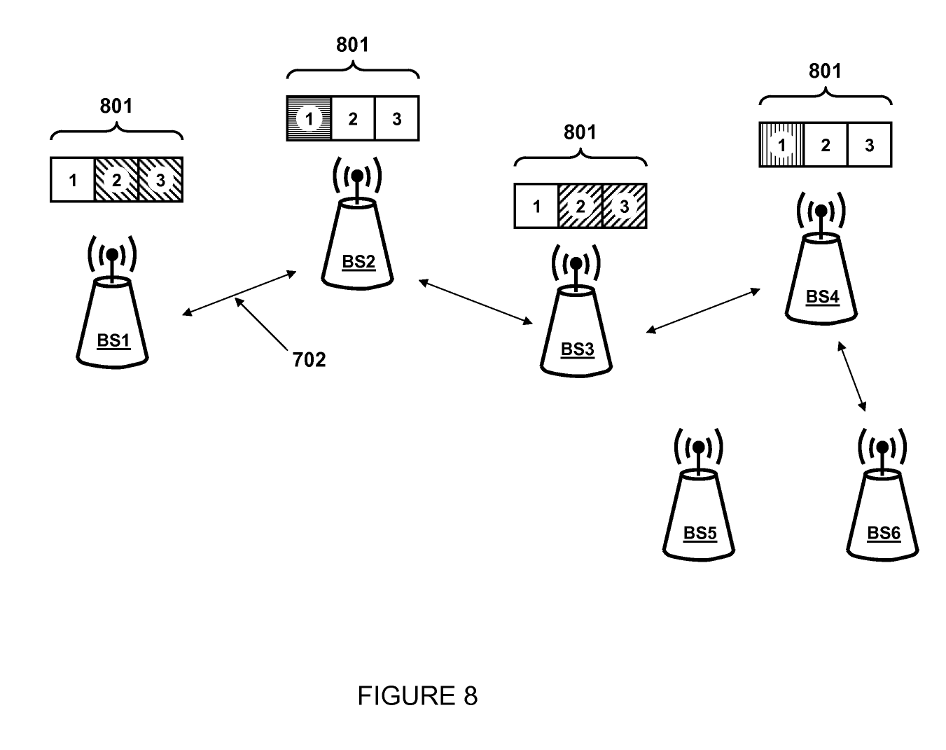

Turning now to FIG. 8, illustrated is a system level diagram of an embodiment of a communication system demonstrating exemplary flexible spectrum use operation according to the principles of the present invention. In this example, there are total of six communication resources used collectively by the first, second, third and fourth base stations BS1, BS2, BS3, BS4, whereas in FIG. 7, only five resources were collectively used. The second base station BS2 has switched from communication resource 3 to 1, and the first base station BS1 has switched from communication resource 1 to 3. Thus, both the first and second base stations BS1, BS2 utilize as many communication resources as before. The third base station BS3 is able to utilize two communication resources instead of just one.

As introduced herein, a base station (or access point) utilizing a distributed flexible spectrum use system monitors communication resources employed by neighboring or more remote base stations and determines an opportunity for collective improvement in the communication system in efficiency of communication resource utilization. For example, communication resource reservations of well-separated neighboring cells may not be overlapping because their communication resource use has not been coordinated. Upon observing such inefficiency in communication resource utilization, the base station (or access point) generates a change request for communication resources employed by at least one of the neighboring or remote base stations based on the determined opportunity for improved utilization of communication resources in the communication system. The opportunity for improved utilization of communication resources may be dependent on a distance or path loss between neighboring or more remote base stations.

A base station can receive information about communication resources employed by a neighboring or more remote base station from a user equipment in a serving area of the base station or directly from one of these base stations over an X2 communication path or over an over-the-air communication path. Correspondingly, the base station can transmit a change request for communication resources employed by one of these base stations to that base station via a user equipment or over an X2 communication path or an over-the-air communication path. The change request to a base station for communication resources can be transmitted via a communication path to the base station that traverses a limited number of intervening base stations.

The change request for an unused communication resource employed by one of the neighboring base stations can free up at least one of the unused communication resources for the base station itself. For example, communication channels/resources C1, C2 may not be employed by the base station itself. The neighboring base stations, which may be sufficiently distant from each other or which may experience sufficient path loss therebetween, do not occupy or employ both communication channels/resources C1, C2. In this case, the neighboring base station using communication channel/resource C1 may change to communication channel/resource C2 and free communication channel/resource C1 for the originating base station that is currently not using either communication channel/resource C1, C2.

The base station (or access point) transmits the change request to at least one of the neighboring or more remote base stations, receives an acknowledgment to the change request, and then initiates a change in response to the acknowledgment. A base station forwards a received change request to other base stations, and then signals an acknowledgment/negative acknowledgment (“ACK/NACK”) to the request when it receives a reply. Based on this sequence, the originating base station can initiate an actual change in the utilization of its own communication resources. Alternatively, the base station can generate an exchange of communication resources employed between two of neighboring base stations. A base station thus determines that inefficiency has been created in collective communication resource utilization among neighboring base stations, and generates and propagates a request in the network to change the allocation of communication resources to improve efficiency of utilization thereof.

A base station will transmit a change request to at least one of the neighboring or more remote base stations and receive an acknowledgement from that neighboring base station. The acknowledgement can be a function of a subsequent change request from the one of the base stations to another of the base stations. For example, a certain base station BSX receives a request to change from communication resource A to B. If none of the base station BSX's neighbors (i.e., other base stations within an interference coordination range) use communication resource B or they have requested themselves that base station BSX change from communication resource A to B, then base station BSX can directly acknowledge (accept) the change. If at least one of the neighboring base stations uses communication resource B, then base station BSX transmits to those base stations a request to change from communication resource B to A, which is opposite to the change requested from base station BSX. The base station BSX's acknowledgement to the received request is then dependent on the response of other base stations to these further requests. The change request process can end when a base station makes the required change and the change does not have any further impact on the rest of the communication system.

Determination of inefficiency in communication resource utilization can be done with normal flexible spectrum use operation by a base station (or access point) gathering information on communication resource use in neighboring or more remote areas or cells. Knowledge of which cells are coordinating communication resource utilization can provide additional input to the process. This information can be signaled as part of the flexible spectrum use operation. Coordination information is likely to change only rarely and, therefore, does not need to be included in every flexible spectrum use beacon.

A direct way to implement improved coordination of the flexible spectrum use operation is to change the communication resource allocation in the cell that observes the inefficiency, and to wait for other cells to adapt to the change, hopefully freeing an additional communication resource in the process. This process adds very little, if any, additional signaling overhead to the communication system. However, a drawback is that neighboring cells may suffer from interference until the change has propagated further and they are able to change their utilization of communication resources.

In an implementation of flexible spectrum use a change request to communication resource allocation (e.g., change a pair of communication resources) is explicitly signaled to a neighboring cell, which is propagated in the communication system until it reaches a point where the communication resource change can be made directly by a base station (or access point) without signaling to any further cells. At that point, the change is made (or agreed to a future time instance) and corresponding changes are propagated back along the original request chain until reaching the source of the request. This signaling may be implemented either using a direct X2 communication path or an over-the-air communication path between base stations, or by user equipment assisted over-the-air communication paths. A broadcast message can also be used to signal neighboring cells. In the case wherein flexible spectrum use operates with a very dynamic process (i.e., flexible spectrum use communication resource allocations change very quickly), it may be necessary to limit the signaling of communication resource change requests to a small number of hops. An advantage of improved coordination of flexible spectrum use communication resource allocations is that the communication resource reuse pattern generated by the flexible spectrum use will be more efficient, and more communication resources can be collectively used by the communication system.

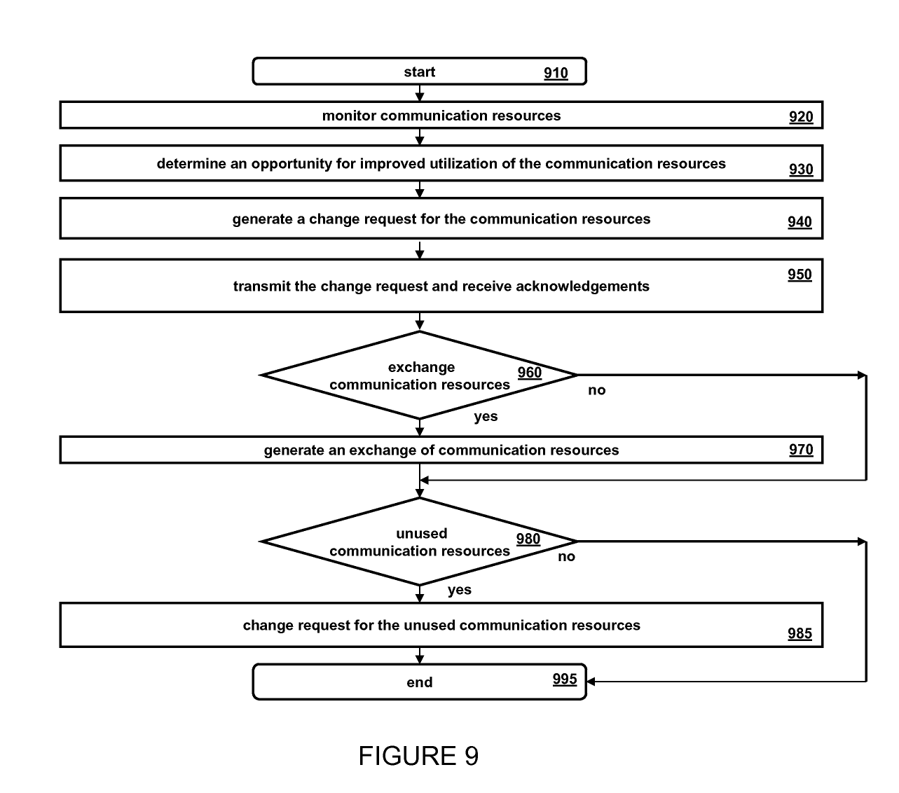

Turning now to FIG. 9, illustrated is a flow diagram of an embodiment of a method of operating a communication element (e.g., a base station) in accordance with the principles of the present invention. In particular, the method demonstrates a base station that accounts for spectrum utilization of wireless communication devices in an area served by one base station and wireless communication devices in another area served by another base station. The method begins at a step or module 910. In a step or module 920, the base station monitors communication resources employed by a plurality of base stations. Ones of the plurality of base stations may be neighboring base stations. The base station may monitor the communication resources employed by the plurality of base stations by receiving a communication from a user equipment in a serving area of the base station or from one of the plurality of base stations over an X2 communication path or over an over-the-air communication path.

In a step or module 930, the base station determines an opportunity for improved utilization of communication resources by the base station and the plurality of base stations. The opportunity for improved utilization of communication resources may be dependent on a distance or a path loss between ones of the plurality of base stations. In a step or module 940, the base station generates a change request for the communication resources employed by at least one of the plurality of base stations based on the opportunity for improved utilization of the communication resources. The change request for the communication resources may be for communication resources employed by the base station itself, or for communication resources employed by another base station. In a step or module 950 the base station transmits the change request to at least one of the plurality of base stations, receives acknowledgment to the change request from at least one of the plurality of base stations.

The change request may be transmitted via the user equipment or via an X2 communication path or an over-the-air communication path to the one of the plurality of base stations. The change request for the communication resources employed by the at least one of the plurality of base stations may be transmitted via a communication path to the one of the plurality of base stations traversing a limited number of the plurality of base stations. The received acknowledgment may be a function of a subsequent change request from the one of the plurality of base stations to another of the plurality of base stations.

In a step or module 960, the base station determines if an exchange of communication resources between two base stations would improve utilization of communication resources. If an exchange of communication resources would improve the utilization, the base station generates an exchange of communication resources between two of the plurality of base stations in a step or module 970. Otherwise, the method continues in a step or module 980.

In a step or module 980, the base station determines if there are unused communication resources for beneficial. If there are unused communication resources for beneficial use, the base station generates a change request for at least one of the unused communication resources employed by at least one of the plurality of base stations in a step or module 985. Otherwise, the method ends in a step or module 990.

Thus, utilization of flexible spectrum use as introduced herein improves efficiency of communication system (such as cellular operation) by accounting for spectrum utilization of wireless communication devices in an area served by one base station and wireless communication devices in another area served by another base station. As should be understood in an exemplary embodiment, a neighboring base station includes base stations not serving a user equipment and is not limited to base stations adjacent the serving base station. An analogous principle applies to neighboring serving areas (and/or cells) to a serving area (or cell) for a particular user equipment. Although the apparatus, method and system described herein have been described with respect to cellular-based communication systems, the apparatus and method are equally applicable to other types of communication systems such as a WiMax® communication system.

Program or code segments making up the various embodiments of the present invention may be stored in a computer readable medium or transmitted by a computer data signal embodied in a carrier wave, or a signal modulated by a carrier, over a transmission medium. For instance, a computer program product including a program code stored in a computer readable medium may form various embodiments of the present invention. The “computer readable medium” may include any medium that can store or transfer information. Examples of the computer readable medium include an electronic circuit, a semiconductor memory device, a read only memory (“ROM”), a flash memory, an erasable ROM (“EROM”), a floppy diskette, a compact disk (“CD”)-ROM, an optical disk, a hard disk, a fiber optic medium, a radio frequency (“RF”) link, and the like. The computer data signal may include any signal that can propagate over a transmission medium such as electronic communication network communication channels, optical fibers, air, electromagnetic links, RF links, and the like. The code segments may be downloaded via computer networks such as the Internet, Intranet, and the like.

As described above, the exemplary embodiment provides both a method and corresponding apparatus consisting of various modules providing functionality for performing the steps of the method. The modules may be implemented as hardware (embodied in one or more chips including an integrated circuit such as an application specific integrated circuit), or may be implemented as software or firmware for execution by a computer processor. In particular, in the case of firmware or software, the exemplary embodiment can be provided as a computer program product including a computer readable storage structure embodying computer program code (i.e., software or firmware) thereon for execution by the computer processor.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. Also, many of the features, functions and steps of operating the same may be reordered, omitted, added, etc., and still fall within the broad scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An apparatus, comprising:
a processor; and
memory including computer program code,
said memory and said computer program code configured to, with said processor, cause said apparatus to perform at least the following:
monitor communication resources employed by a plurality of base stations;
determine an opportunity for improved utilization of said communication resources by said apparatus and said plurality of base stations; and
generate a change request for said communication resources employed by at least one of said plurality of base stations based on said opportunity for improved utilization thereof.

2. The apparatus as recited in claim 1 wherein said memory and said computer program code is configured to, with said processor cause said apparatus to transmit said change request to at least one of said plurality of base stations, receive acknowledgements to said change request and initiate a change in response to said acknowledgements.

3. The apparatus as recited in claim 1 wherein said memory and said computer program code is configured to, with said processor cause said apparatus to transmit said change request to at least one of said plurality of base stations and receive an acknowledgement from one of said plurality of base stations, wherein said acknowledgement is a function of a subsequent change request from said one of said plurality of base stations to another of said plurality of base stations.

4. The apparatus as recited in claim 1 wherein said memory and said computer program code is configured to, with said processor, cause said apparatus to generate said change request for said communication resources employed by said apparatus.

5. The apparatus as recited in claim 1 wherein said memory and said computer program code is configured to, with said processor, cause said apparatus to generate an exchange of communication resources employed between two of said plurality of base stations.

6. The apparatus as recited in claim 1 wherein said communication resources comprise unused communication resources for said apparatus, said memory and said computer program code is configured to, with said processor, cause said apparatus to generate a change request for at least one of said unused communication resources employed by at least one of said plurality of base stations, thereby freeing up said at least one of said unused communication resources for said apparatus.

7. The apparatus as recited in claim 1 wherein said memory and said computer program code is configured to, with said processor, cause said apparatus to transmit said change request for said communication resources employed by at least one of said plurality of base stations via a communication path to said one of said plurality of base stations traversing a limited number of said plurality of base stations.

8. The apparatus as recited in claim 1 wherein said opportunity for improved utilization of said communication resources is dependent on a distance or a path loss between ones of said plurality of base stations.

9. The apparatus as recited in claim 1 wherein said memory and said computer program code is configured to, with said processor, cause said apparatus to receive information about said communication resources employed by at least one of said plurality of base stations from a user equipment in a serving area of said apparatus or from one of said plurality of base stations over an X2 communication path or an over-the-air communication path.

10. The apparatus as recited in claim 1 wherein said memory and said computer program code is configured to, with said processor, cause said apparatus to transmit said change request for said communication resources employed by at least one of said plurality of base stations via a user equipment, or an X2 communication path or an over-the-air communication path to said one of said plurality of base stations.

11. A computer program product comprising a program code stored in a computer readable medium configured to:
monitor communication resources employed by a plurality of base stations;
determine an opportunity for improved utilization of said communication resources by said apparatus and said plurality of base stations; and
generate a change request for said communication resources employed by at least one of said plurality of base stations based on said opportunity for improved utilization thereof.

12. The computer program product as recited in claim 11 wherein said program code stored in said computer readable medium is further configured to transmit said change request to at least one of said plurality of base stations, receive acknowledgements to said change request and initiate a change in response to said acknowledgements.

13. The computer program product as recited in claim 11 wherein said program code stored in said computer readable medium is further configured to transmit said change request to at least one of said plurality of base stations and receive an acknowledgement from one of said plurality of base stations, wherein said acknowledgement is a function of a subsequent change request from said one of said plurality of base stations to another of said plurality of base stations.

14. The computer program product as recited in claim 11 wherein said program code stored in said computer readable medium is further configured to generate a change request for at least one of said unused communication resources employed by at least one of said plurality of base stations, thereby freeing up said at least one of said unused communication resources for a base station.

15. A method, comprising:
monitoring communication resources employed by a plurality of neighboring base stations;
determining an opportunity for improved utilization of said communication resources by a base station and said plurality of neighboring stations; and
generating a change request for said communication resources employed by at least one of said plurality of neighboring base stations based on said opportunity for improved utilization thereof.

16. The method as recited in claim 15 further comprising transmitting said change request to at least one of said plurality of neighboring base stations, receive acknowledgements to said change request and initiate a change in response to said acknowledgements.

17. The method as recited in claim 15 further comprising transmitting said change request to at least one of said plurality of neighboring base stations and receive an acknowledgement from one of said plurality of neighboring base stations, wherein said acknowledgement is a function of a subsequent change request from said one of said plurality of neighboring base stations to another of said plurality of neighboring base stations.

18. The method as recited in claim 15 further comprising generating said change request for said communication resources employed by said base stations.

19. The method as recited in claim 15 further comprising generating an exchange of communication resources employed between two of said plurality of base stations.

20. The method as recited in claim 15 wherein said communication resources comprise unused communication resources for said base station, said method further comprising generating a change request for at least one of said unused communication resources employed by at least one of said plurality of neighboring stations, thereby freeing up said at least one of said unused communication resources for said base station.
